(19) United States
(12) Patent Application Publication
(10) Pub. No.: US 2013/0127439 A1
(43) Pub. Date: May 23, 2013

(54) VOLTAGE ADJUSTMENT CIRCUIT

(71) Applicants: YING-BIN FU, Shenzhen City (CN); YUAN-XI CHEN, Shenzhen City (CN)

(72) Inventors: YING-BIN FU, Shenzhen City (CN); YUAN-XI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/449,358

(22) Filed: Apr. 18, 2012

(30) Foreign Application Priority Data
Nov. 22, 2011 (CN) 201110373420.0

(51) Int. Cl. H02J 4/00

(52) U.S. Cl. 323/353

(57) ABSTRACT

A voltage adjustment circuit includes a programmable resistor, a keyboard, and a microprocessor control unit (MCU). The programmable resistor includes an input connected to a first power supply to receive a first voltage. The MCU is connected to the keyboard and the programmable resistor. A preset voltage is set through the keyboard. The MCU adjusts a resistance of the programmable resistor according to the preset voltage, such that the programmable resistor outputs a second voltage.

### BACKGROUND

1. Technical Field

The present disclosure relates to a voltage adjustment circuit.

2. Description of Related Art

Many electronic devices, such as computers, need be tested after being manufactured. For testing the electronic device, different voltages, such as 5 volts, 5.5 volts, and 4.5 volts, are supplied for the electronic device. Different power supplies are needed to provide different operating voltages. Thus, it is complicated and costly.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a voltage adjustment circuit.

FIGS. 2-4 are circuit diagrams of the voltage adjustment circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

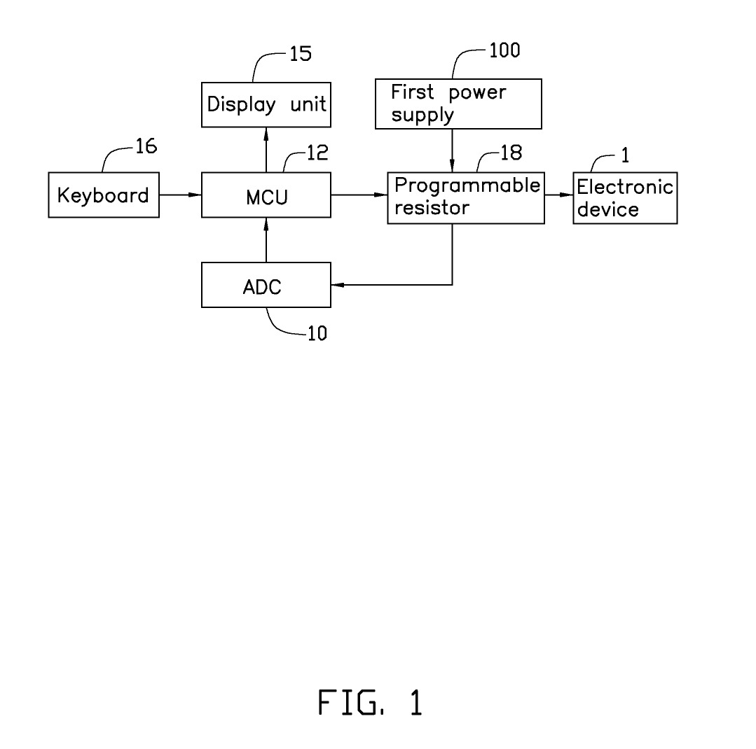

FIG. 1, is an exemplary embodiment of a voltage adjustment circuit used to provide different voltages to an electronic device 1 including an analog-to-digital converter (ADC) 10, a microprocessor control unit (MCU) 12, a display unit 15, a keyboard 16, and a programmable resistor 18.

The programmable resistor 18 is connected to a first power supply 100, to receive a first voltage. The programmable resistor 18 is further connected to the electronic device 1, for outputting a second voltage to the electronic device 1.

The keyboard 16 and the programmable resistor 18 are connected to the MCU 12. The keyboard 16 is used to set a preset voltage. The MCU 12 adjusts a resistance of the programmable resistor 18 according to the preset voltage set through the keyboard 16, such that the programmable resistor 18 outputs the second voltage.

The programmable resistor 18 is further connected to the ADC 10, to output the second voltage to the ADC 10. The ADC 10 converts the second voltage to a corresponding digital signal, and transmits the digital signal to the MCU 12. The MCU 12 is further connected to the display unit 15. The display unit 15 displays the second voltage.

The MCU 12 further compares the second voltage received from the programmable resistor 18 with the preset voltage set through the keyboard 16 to determine whether the preset voltage is the same as the second voltage. If the two voltages are different, the MCU 12 adjusts the resistance of the programmable resistor 18 according to the difference to make the second voltage output from the programmable resistor 18 the same as the preset voltage.

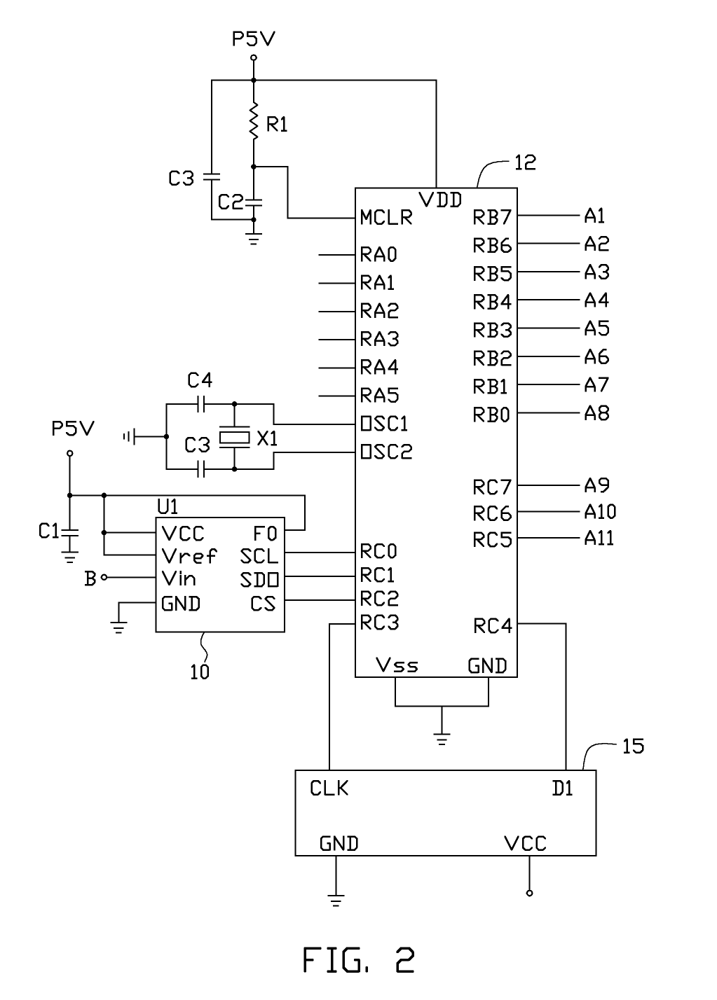

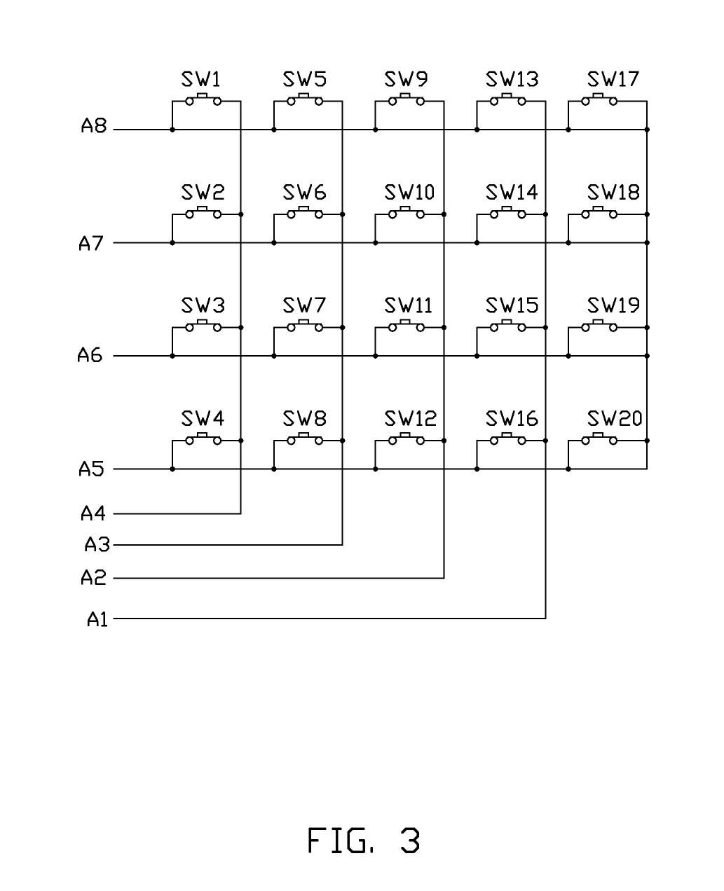

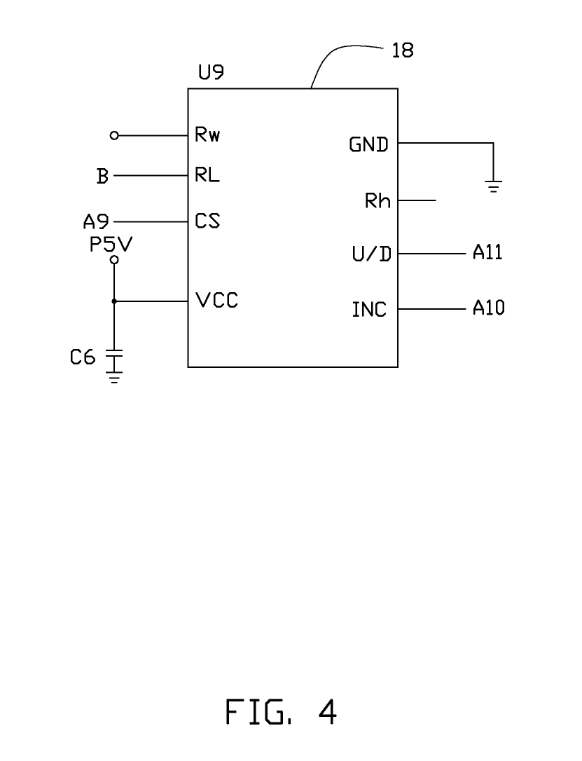

FIGS. 2-4, show the ADC 10 is a chip U1. A voltage pin VCC and a reference input pin Vref of the ADC 10 are both connected to a second power supply P5V. The second power supply P5V is further grounded through a capacitor C1. An analog input pin Vin of the ADC 10 is connected to the output of the programmable resistor 18 (FIG. 4). A ground pin GND of the ADC 10 is grounded. An active low digital input pin CS, a three-state digital output pin SDO, and a clock pin SCL of the ADC 10 are all connected to the MCU 12. A frequency control pin F0 of the ADC 10 is connected to the second power supply P5V. The second power supply P5V supplies power for the ADC 10.

A reset pin MCLR of the MCU 12 is connected to the second power supply P5V through a resistor R1, and is grounded through a capacitor C2. The second power supply P5V is further grounded through a capacitor C3. A first group of digital input and output (I/O) pins RA0-RA5 are idle. A ground reference pin Vss is grounded. Two clock input pins OSC1 and OSC2 are connected to two corresponding terminals of a crystal oscillator X1. The two terminals of the crystal oscillator X1 are grounded through corresponding capacitors C4 and C5. A second group of digital I/O pins of the MCU 12 includes first to eighth pins RC0-RC7. The first pin RC0 of the second group of digital I/O pins is connected to the clock pin SCL of the ADC 10. The second pin RC1 of the second group of digital I/O pins is connected to the three-state digital output pin SDO of the ADC 10. The third pin RC2 of the second group of digital I/O pins is connected to the active low digital input pin CS of the ADC 10. The fourth and fifth pins RC3 and RC4 of the second group of digital I/O pins are respectively connected to a clock pin CLK and a data pin D1 of the display unit 15. A ground pin GND of the display unit 15 is grounded. A power pin VCC of the display unit 15 is connected to a third power supply.

The sixth to eighth pins RC5, RC6, and RC7 of the second group of digital I/O pins are connected to the programmable resistor 18. A ground pin GND is grounded. A power pin VDD is connected to the second power supply P5V. A third group of digital I/O pins include first to eighth pins RB0-RB7 connected to the keyboard 16. The crystal oscillator X1 provides a working clock for the MCU 12. The second power supply P5V supplies power to the MCU 12.

The programmable resistor 18 is a chip U9. An increment control pin INC is connected to the seventh pin RC6 of the second group of digital I/O pins of the MCU 12. An up and down control pin U/D is connected to the sixth pin RC5 of the second group of digital I/O pins of the MCU 12. A potentiometer high terminal pin Rh is idle. A ground pin GND is grounded. A potentiometer wiper terminal pin Rw is connected to the first power supply 100. A potentiometer low terminal pin RL is connected to the analog input pin Vin of the ADC 10, and connected to the electronic device 1. A chip select pin CS is connected to the eighth pin RC7 of the second group of digital I/O pins of the MCU 12. A power pin VCC is connected to the second power supply P5V, and is grounded through a capacitor C6. The second power supply P5V supplies power to the programmable resistor 18.

The keyboard 16 includes twenty switches SW1 to SW20. First terminals of the switches SW1 to SW4 are connected to the fifth pin RB4 of the third group of digital I/O pins of the MCU 12. First terminals of the switches SW5 to SW8 are connected to the sixth pin RB5 of the third group of digital I/O pins of the MCU 12. First terminals of the switches SW9 to SW12 are connected to the seventh pin RB6 of the third group of digital I/O pins of the MCU 12. First terminals of the switches SW13 to SW16 are connected to the eighth pin RB7 of the third group of digital I/O pins of the MCU 12. First terminals of the switches SW17 to SW20 are connected to the fourth pin RB3 of the third group of digital I/O pins of the MCU 12. Second terminals of the switches SW1, SW5, SW9, SW13, and SW17 are connected to the first pin RB0 of the third group of digital I/O pins of the MCU 12. Second terminals of the switches SW2, SW6, SW10, SW14, and SW18 are connected to the second pin RB1 of the third group of digital I/O pins of the MCU 12. Second terminals of the switches SW3, SW7, SW11, SW15, and SW19 are connected to the third pin RB2 of the third group of digital I/O pins of the MCU 12. Second terminals of the switches SW4, SW8, SW12, SW16, and SW20 are connected to the fourth pin RB3 of the third group of digital I/O pins of the MCU 12.

In the embodiment, the first voltage from the first power supply 100 is 3 volts, namely the potentiometer wiper terminal pin Rw of the programmable resistor 18 receives the 3 volts, the potentiometer low terminal pin RL of the programmable resistor 18 outputs a 3.5 volts according to the parameter of the programmable resistor 18. The ADC 10 converts the 3.5 volts to a digital signal and transmits the digital signal to the MCU 12. The display unit 15 displays the digital signal to show that the programmable resistor 18 outputs the 3.5 volts.

When the voltage supplied to the electronic device 1 needs to be adjusted, operators set a preset voltage, such as 3.15 volts through the keyboard 16. The MCU 12 adjusts the resistance of the programmable resistor 18 accordingly. In the embodiment, the keyboard 16 is a matrix keyboard circuit which includes four rows and five lines. The MCU 12 detects the statuses of the twenty switches SW1-SW20 to determine which switch is turned on, and executes programs stored in the MCU 12 according to the adjusted resistance of the programmable resistor 18.

After the resistance of the programmable resistor 18 has been adjusted, the sixth pin RL of the programmable resistor 18 outputs the second voltage. The ADC 10 converts the second voltage to a digital signal and transmits the digital signal to the display unit 16. The display unit 16 displays the second voltage. In addition, the MCU 12 compares the second voltage with the preset voltage. If the second voltage is different from the preset voltage, the MCU 12 adjusts the resistance of the programmable resistor 18 according to the difference between the second voltage and the preset voltage to make the second voltage output from the programmable resistor 18 the same as the preset voltage.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A voltage adjustment circuit, comprising:
a programmable resistor comprising an input connected to a first power supply to receive a first voltage;
a keyboard; and
a microprocessor control unit (MCU) connected to the keyboard and the programmable resistor, wherein a preset voltage is operable to be set through the keyboard, the MCU adjusts a resistance of the programmable resistor according to the preset voltage, such that the programmable resistor outputs a second voltage.

2. The voltage adjustment circuit of claim 1, further comprising an analog-to-digital converter (ADC), wherein the ADC is connected to the programmable resistor to receive the second voltage and convert the second voltage to a digital signal, the ADC is further connected to the MCU to transmit the digital signal to the MCU, the MCU further compares the second voltage corresponding to the digital signal from the ADC with the preset voltage, wherein if the second voltage and the preset voltage are different, the MCU adjusts the resistance of the programmable resistor according to the difference, to make the second voltage output from the programmable resistor be same as the preset voltage.

3. The voltage adjustment circuit of claim 2, further comprising a display unit connected to the MCU, wherein the MCU transmits the digital signal from the ADC to the display unit, the display unit displays the second voltage corresponding to the digital signal.

4. The voltage adjustment circuit of claim 3, wherein a reset pin of the MCU is connected to a second power supply through a first resistor, and is grounded through a first capacitor, a first group of digital input and output (I/O) pins of the MCU are idle, a ground reference pin of the MCU is grounded, two clock pins of the MCU are respectively connected to two terminals of a crystal oscillator, the two terminals of the crystal oscillator are respectively grounded through a second capacitor and a third capacitor, first to third pins of a second group of digital I/O pins of the MCU are connected to the ADC, fourth and fifth pins of the second group of digital I/O pins of the MCU are connected to the display unit, sixth to eighth pins of the second group of pins of the MCU are connected to the programmable resistor, a ground pin of the MCU is grounded, a power pin of the MCU is connected to the second power supply, first to eighth pins of a third group of digital I/O pins of the MCU are connected to the keyboard.

5. The voltage adjustment circuit of claim 4, wherein a voltage pin and a reference input pin of the ADC are both connected to the second power supply, an analog input pin of the ADC is connected to the programmable resistor, a ground pin of the ADC is grounded, an active low digital input pin, a three-state digital output pin, and a clock pin of the ADC are connected to the MCU, a frequency control pin of the ADC is connected to the second power supply.

6. The voltage adjustment circuit of claim 5, wherein an increment control pin of the programmable resistor is connected to the seventh pin of the second group of digital I/O pins of the MCU, an up and down control pin of the programmable resistor is connected to the sixth pin of the second group of digital I/O pins of the MCU, a potentiometer high terminal pin of the programmable resistor is idle, a ground pin of the programmable resistor is grounded, a potentiometer wiper terminal pin of the programmable resistor is connected to the first power supply, a potentiometer low terminal pin of the programmable resistor is connected to the analog input pin of the ADC and the electronic device, a chip select pin of the programmable resistor is connected to the eighth pin of the second group of digital I/O pins of the MCU, a power pin of the programmable resistor is connected to the second power supply, and is grounded through a fourth capacitor.

7. The voltage adjustment circuit of claim 6, wherein the keyboard comprises first to twentieth switches, first terminals of the first to fourth switches are connected to the fifth pin of the third group of digital I/O pins of the MCU, first terminals of the fifth to eighth switches are connected to the sixth pin of the third group of digital I/O pins of the MCU, first terminals of the ninth to twelfth switches are connected to the seventh pin of the third group of digital I/O pins of the MCU, first terminals of the thirteenth to sixteenth switches are connected to the eighth pin of the third group of digital I/O pins of the MCU, first terminals of the seventeen to twentieth switches are connected to the fourth pin of the third group of digital I/O pins of the MCU, second terminals of the first switch, the fifth switch, the ninth switch, the thirteenth switch, and the seventeenth switch are connected to the first pin of the third group of digital I/O pins of the MCU, second terminals of the second switch, the sixth switch, the tenth switch, the fourteenth switch, and the eighteenth switch are connected to the second pin of the third group of digital I/O pins of the MCU, second terminals of the third switch, the seventh switch, the eleventh switch, the fifteenth switch, and the nineteenth switch are connected to the third pin of the third group of digital I/O pins of the MCU, second terminals of the fourth switch, the eighth switch, the twelfth switch, the sixteen switch, and the twentieth switch are connected to the fourth pin of the third group of digital I/O pins of the MCU.
